(19) United States
(12) Patent Application Publication
(10) Pub. No.: US 2005/0152394 A1
(43) Pub. Date: Jul. 14, 2005

(54) Method of transferring a TCP stream in PAN

(75) Inventor: Jun-haeng Cho, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/033,255

(22) Filed: Jan. 12, 2005

(30) Foreign Application Priority Data
Jan. 13, 2004 (KR) 2004-02155

(51) Int. Cl. H04B 7/212

(52) U.S. Cl. 370/442

(57) ABSTRACT

A method of transferring a TCP stream in a Personal Area Network (PAN) synchronized with a synchronous signal broadcasted from a coordinator, including: transmitting to the coordinator, via a first device at a sending side desiring to send the TCP stream among plural devices linked to the PAN, a channel time request command including information that a stream to be used is a TCP stream to request a channel time allocation; allocating, via the coordinator by referring to the channel time request command, a channel time corresponding to the channel time requested by the first device; inserting information on the allocated channel time into the synchronous signal broadcast to the first device and a second device at a receiving side; and transmitting the TCP data from the first device to the second device and transmitting a TCP acknowledgement (ACK) from the second device to the first device upon receipt of the TCP data, the transmitting and receiving being in the allocated channel time inserted into the synchronous signal.

### CROSS-REFERENCE TO RELATED APPLICATION

This application claims the benefit of Korean Patent Application No. 2004-02155 filed on Jan. 13, 2004, in the Korean Intellectual Property Office, the disclosure of which is incorporated herein by reference.

### BACKGROUND OF THE INVENTION

1. Field of the Invention

The present invention relates to a method of transferring a TCP stream in a Personal Area Network (PAN). More particularly, the present invention relates to a method of transferring a TCP stream in a Personal Area Network (PAN), which transfers the TCP stream without a crash in an allocated channel time by use of a single channel and is able to effectively use channels.

2. Description of Related Art

A Personal Area Network (PAN), as opposed to known networks like a Local Area Network (LAN) or a Wide Area Network (WAN), is a network in which every individual user has his own network. Devices owned by an individual form a single network for the user's own convenience. A Wireless Personal Network (WPAN) is a wireless PAN.

For realizing a wireless PAN, the IEEE 802.15 Working Group set WPAN as the standard for short haul wireless networks and has four Task Groups (TG) thereunder. IEEE 802.15.1 is for so-called Bluetooth. IEEE 802.15.3 and IEEE 802.15.3a are for a high rate WPAN, and IEEE 802.15.4, so-called ZigBee, performs standardization of low rate WPAN.

FIG. 1 is a view illustrating a construction of a conventional wireless personal area network. In the wireless personal area network, plural data devices DEV1-DEV5, respectively denoted by reference numerals 10-50, form a single piconet with one device thereof operating as a piconet coordinator (PNC) 50.

PNC 50 broadcasts a synchronous signal (i.e., a beacon) to the rest of the devices DEV1 10, DEV2 20, DEV3 30 and DEV4 40, thereby synchronizing the devices linked with the piconet. When a WPAN according to IEEE 802.15.3 standard or advanced standards such as IEEE 802.15.3a (hereinafter IEEE 802.15.3x) is employed, a superframe is used and FIG. 2 illustrates a construction of the superframe.

Since Carrier Sense Multiple Access with Collision Avoidance (CSMA/CA), which has been used widely, cannot provide quality of signal (QoS) in IEEE 802.15.3x high rate WPAN, a method of using Channel Time Allocation (CTA) is used, which is similar to Time Division Multiple Access (TDMA). The channel time which a device desires to use is reported to the PNC 50 by a channel time request command during a Contention Access Period (CAP). The PNC 50 reviews the channel time request command, broadcasts the scheduled result via a CTA Information Element (IE) of the beacon frame to the devices, and accordingly, the corresponding devices transmit and receive data in its own channel time allocation. The CTA can be used only by corresponding devices, and therefore, QoS can be guaranteed.

In accesses such as a User Datagram Protocol (UDP), in which an acknowledgement (ACK) is not necessary in a transport layer, data can be continuously transmitted in a given channel time when devices at a sending side have data to be transmitted.

In a Transmission Control Protocol (TCP), however, when a data packet is transmitted in a Channel Time Allocation of devices at a sending side, devices at a receiving side return an ACK packet so as to inform devices at a receiving side that the data packet transmitted from devices at a sending side has been successfully transmitted. At this time, devices at the sending side cannot transmit any data until the devices at the receiving side allocate a new channel time and transmit ACK packet to the devices at the sending side, and accordingly, the entire communication efficiency can be decreased.

Conventionally, devices at a receiving side transmit an ACK of a Medium Access Control (MAC) level in the same channel time to devices at a sending side. However, devices at the receiving side cannot transmit a TCP ACK in the same channel time, and should allocate a new channel time for the TCP ACK. Therefore, an allocated channel time cannot be used.

A conventional method supporting a TCP has up-link and down-link, respectively. According to this method, however, a controller has to control both of two channels being used, and therefore, overhead increases.

### BRIEF SUMMARY

An aspect of the present invention is to provide a method of transferring TCP stream in PAN wherein the devices at a receiving side do not need to be allocated with a new channel time for transferring ACK packet, and devices at a sending side send and receive data packet and ACK packet in an allocated channel time to effectively use channels.

In order to achieve the above-described aspects and/or other features of the present invention, there is provided a method of transferring a TCP stream in a Personal Area Network (PAN) synchronized with a synchronous signal broadcasted from a coordinator, including: transmitting to the coordinator, via a first device at a sending side desiring to send the TCP stream among plural devices linked to the PAN, a channel time request command including information that a stream to be used is a TCP stream to request a channel time allocation; allocating, via the coordinator by referring to the channel time request command, a channel time corresponding to the channel time requested by the first device; inserting information on the allocated channel time into the synchronous signal broadcast to the first device and a second device at a receiving side; and transmitting the TCP data from the first device to the second device and transmitting a TCP acknowledgement (ACK) from the second device to the first device upon receipt of the TCP data, the transmitting and receiving being in the allocated channel time inserted into the synchronous signal.

The PAN may be a Wireless Personal Area Network (WPAN).

Requesting the channel time allocation may include informing that the stream is a TCP by use of the first bit of a reserved field among CTRq control field as a predetermined value, in the channel time request command.

The inserting may add a specified index among index fields in CTA IE provided in a beacon frame used as a synchronous signal to inform that a stream to be transmitted from the first device at a sending side to devices at a receiving side is TCP.

The predetermined index may be 0x01.

The transmitting may include: transmitting a MAC fragment from the first device at a sending side to devices at a receiving side and switching a transmitting mode Tx of the first device to a receiving mode Rx to listen to confirm whether devices at the receiving side have a ACK packet to transmit; and switching a receiving mode Rx of the devices at the receiving side to a transmitting mode Tx to transmit the ACK packet, when the devices at the receiving side have an ACK packet to transmit.

The method may further include switching a receiving mode Rx of the first device to a transmitting mode Tx to continuously transmit a MAC fragment, when the devices at the receiving side have no ACK packet to transmit.

According to another embodiment of the present invention, there is provided a method of decreasing transmission delay of a TCP stream in a network, including: requesting a channel time allocation by transmitting to a coordinator a channel time request command which includes information that a stream to be transmitted is a TCP stream; allocating a channel time corresponding to the channel time requested based on the channel time request command; inserting information on the allocated channel time into a synchronous signal broadcast from a coordinator; and transmitting the TCP stream and a TCP acknowledgement (ACK) in the allocated channel time inserted into the synchronous signal.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a view illustrating a construction of a conventional wireless personal area network;

FIG. 2 is a view illustrating a construction of a superframe according to IEEE 802.15.3 standard;

FIG. 3 is a view illustrating a channel time request command being transmitted to a PNC by devices at a sending side to request channel time;

FIG. 4 is a view of a construction of a CTA IE;

FIG. 5 is a view illustrating a stream index being newly-defined according to embodiment of the present invention;

FIG. 6 is a view explaining a method for using channel time when No ACK policy is applied; and

FIG. 7 is a view explaining a method for using channel time when an immediate ACK policy is applied.

### DETAILED DESCRIPTION OF EMBODIMENTS

Reference will now be made in detail to an embodiment of the present invention, examples of which are illustrated in the accompanying drawings, wherein like reference numerals refer to the like elements throughout. The embodiment is described below in order to explain the present invention by referring to the figures.

The method of transferring a TCP stream in a WPAN according to an embodiment of the present invention is hereafter described applied to a WPAN environment based on the IEEE 802.15.3 standard. However, it is to be understood that the method is applicable not only to the WPAN, but also to the other wireless networks. Also, known functions or constructions are not described in detail.

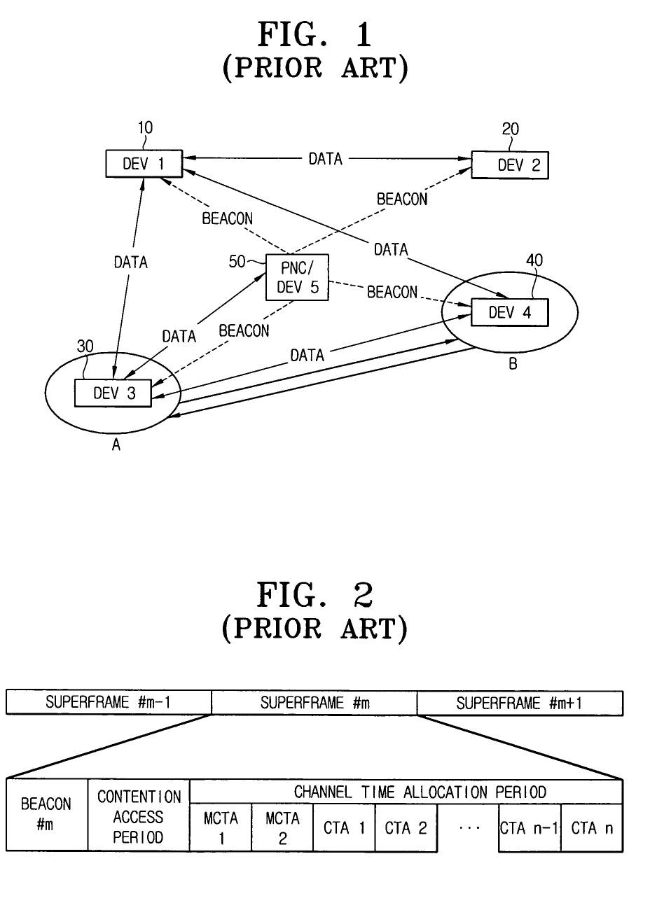

In FIG. 1, devices at a sending side such as DEV3 30, devices at a receiving side such as DEV4 40 are described. Devices at a sending side request a channel time allocation to a piconet coordinator PNC 50 to transmit TCP stream, and inform that a stream is to be transmitted is a TCP. Devices at a sending side transmit a channel time request command to PNC 50 to request channel time to PNC 50.

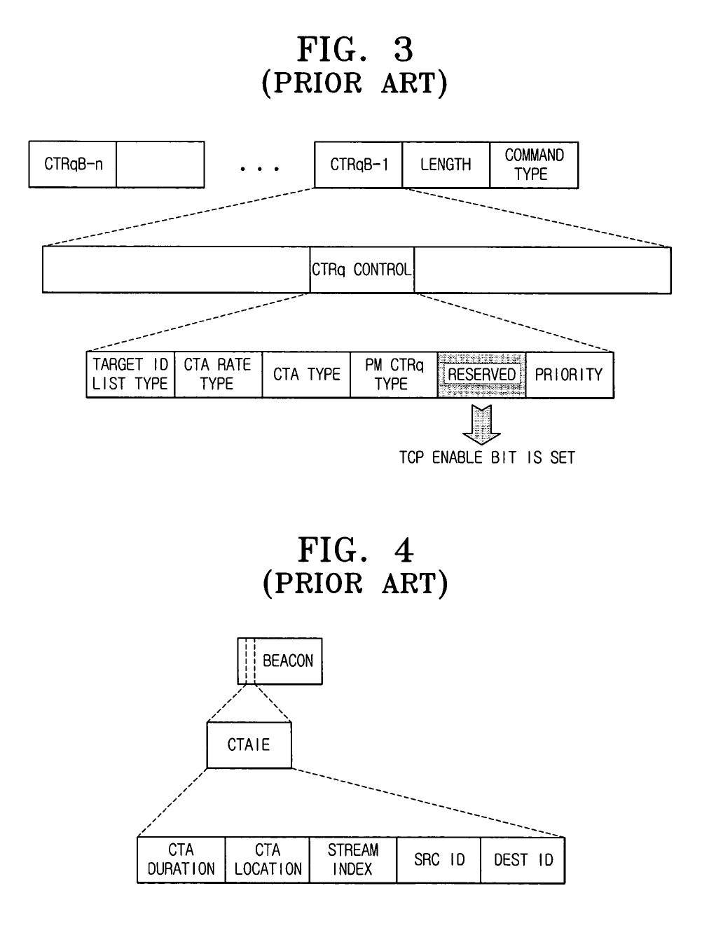

FIG. 3 is a view illustrating a channel time request command being transmitted to the PNC by devices at a sending side to request a channel time. A field used when devices at a sending side (such as DEV3 30) requests a channel time is a reserved field in the CTRq control field.

The first bit of the reserved field is in advance set as ‘TCP enable bit’ to transmit a channel time request command to PNC 50. Therefore, PNC 50 knows that the stream to be transmitted by devices at a sending side (such as DEV3 30) is a TCP.

PNC 50 reviews the channel time request and allocates a channel time to devices at a sending side, and generates a beacon including information about the allocated channel time. PNC 50 broadcasts the beacon to devices at a sending side (such as DEV3 30) and devices at a receiving side (such as DEV4 40). FIG. 4 illustrates CTA IE including information on the allocated channel time in beacon broadcasted by PNC 50.

PNC 50 accepts the TCP stream transmission request of devices at a sending side and amends a stream index field in the CTA IE in the beacon to inform that the stream to be transmitted is TCP. For amending the stream index field, a specified index is added to newly define a stream index field.

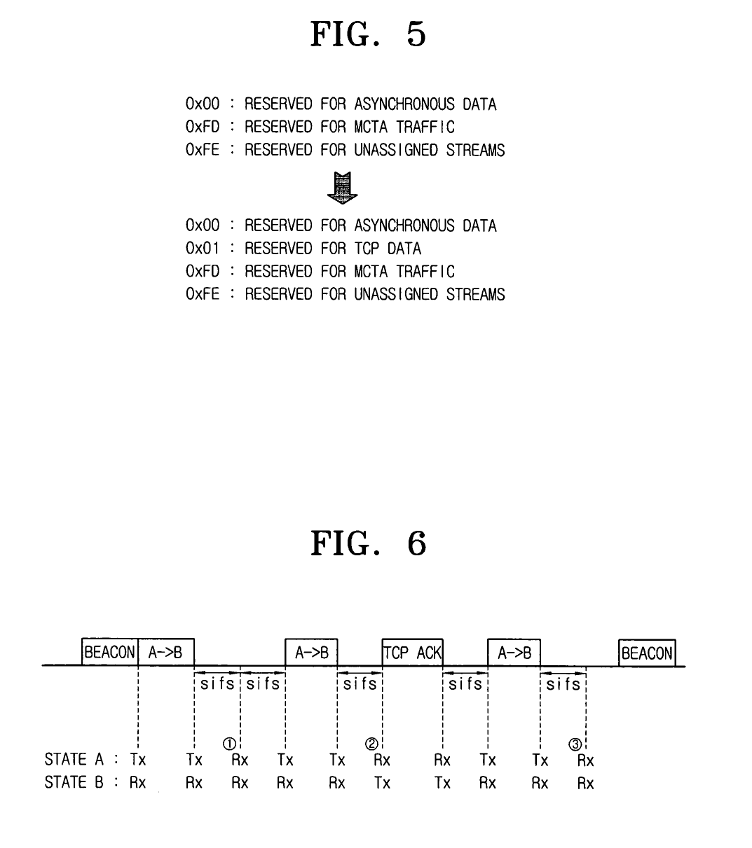

FIG. 5 is a view illustrating a newly-defined stream index according to the present embodiment. The specified index being newly added is 0x01 and an index being in advance allocated to inform that a stream to be transmitted by devices at a sending side (such as DEV3 30) and devices at a receiving side (such as DEV3 30) is a TCP.

PNC 50 broadcasts the CTA IE including the stream index corrected by adding 0x01 to devices at a sending side (such as DEV3 30) and devices at a receiving side (such as DEV4 40) so that the devices 30 and 40 know that stream to be transmitted is a TCP.

Devices at a sending side and devices at a receiving side according to the above method transmit and receive data without a crash in a channel time allocated by the PNC 50.

FIG. 6 is a view explaining data transmission of devices at a sending side (such as DEV3 30) and devices at a receiving side (such as DEV4 40) in a channel time allocated by the PNC 50 when a No ACK policy is applied. No ACK policy means that the devices at a sending side are switched to a receiving mode not to receive an ACK of a MAC level but to receive the TCP ACK directly.

Devices at a sending side (such as DEV3 30) transmit a MAC fragment to devices at a receiving side (such as DEV4 40), switch from a transmitting mode Tx to a receiving mode Rx, and temporally stay in a listening status to confirm whether devices at a receiving side have an ACK to be transmitted.

When sensing that a channel is idle, that is, when it is confirmed that no ACK packet is transmitted by devices at a receiving side (such as DEV4 40), devices at a sending side (such as DEV3 30) are switched from receiving mode Rx to transmitting mode Tx to continuously transmit the MAC fragment to devices at a receiving side.

The above process repeats and, when devices at a receiving side (such as DEV4 40) have an ACK packet to be transmitted at a time point Tₚ, the devices at a receiving side are switched from receiving mode Rx to transmitting mode Tx to transmit the ACK packet.

When transmission of the ACK packet is completed, the devices at a receiving side (such as DEV4 40) are switched from the transmitting mode Tx to receiving mode Rx, and when devices at a sending side (such as DEV3 30) have a MAC fragment to be further transmitted, the devices at the sending side are switched to transmitting mode Tx to start transmitting. When devices at a receiving side have ACK packet to be transmitted, the devices at the receiving side are switched to transmitting mode Tx to transmit the ACK packet.

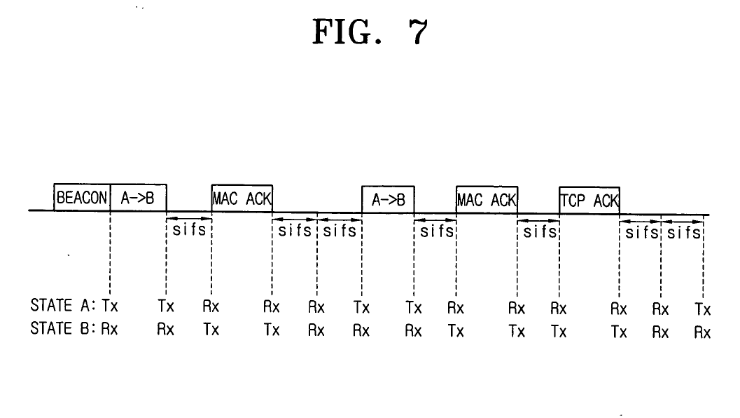

FIG. 7 is a view explaining a method of using a channel time when an immediate ACK policy is applied. An immediate ACK policy means that devices at a sending side (such as DEV3 30) are switched to receiving mode to receive an ACK of a MAC level and then to receive an TCP ACK. Operations of devices at the sending side and the receiving side under an immediate ACK policy are the same as those under the No ACK policy in FIG. 6, save the devices transmit and receive an ACK of a MAC level.

As described above, the method of transferring TCP stream in PAN according to the above-described embodiment transmits TCP stream without a crash by use of a channel in an allocated channel time to effectively use channel, decreases transmission delay of TCP stream, and therefore, is able to increase the entire performance of system.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

1. A method of transferring a TCP stream in a Personal Area Network (PAN) synchronized with a synchronous signal broadcasted from a coordinator, comprising:
transmitting to the coordinator, via a first device at a sending side desiring to send the TCP stream among plural devices linked to the PAN, a channel time request command including information that a stream to be used is a TCP stream to request a channel time allocation;
allocating, via the coordinator by referring to the channel time request command, a channel time corresponding to the channel time requested by the first device;
inserting information on the allocated channel time into the synchronous signal broadcast to the first device and a second device at a receiving side; and
transmitting the TCP data from the first device to the second device and transmitting a TCP acknowledgement (ACK) from the second device to the first device upon receipt of the TCP data, the transmitting and receiving being in the allocated channel time inserted into the synchronous signal.

2. The method of transferring a TCP stream in a PAN as claimed in claim 1, wherein, in the transmitting, the PAN is a Wireless Personal Area Network (WPAN).

3. The method of transferring a TCP stream in a PAN as claimed in claim 1, wherein the requesting the channel time allocation includes informing that the stream is a TCP by use of the first bit of a reserved field among a CTRq control field, in the channel time request command.

4. The method of transferring a TCP stream in a PAN as claimed in claim 1, wherein, in the inserting, a predetermined index among index fields in a Channel Time Allocation (CTA) IE provided in a beacon frame used as a synchronous signal to inform that a stream to be transmitted from the first device at a sending side to devices at a receiving side is a TCP is added.

5. The method of transferring a TCP stream in a PAN as claimed in claim 4, wherein the predetermined index is 0x01.

6. The method of transferring a TCP stream in a PAN as claimed in claim 1, wherein the transmitting includes:
transmitting a Medium Access Control (MAC) fragment from the first device to devices at the receiving side and switching a transmitting mode Tx of the first device to a receiving mode Rx to listen to confirm whether devices at the receiving side have an acknowledgement (ACK) packet to transmit; and
switching the receiving mode Rx of the devices at the receiving side to the transmitting mode Tx to transmit the ACK packet, when the devices at the receiving side have an ACK packet to transmit.

7. The method of transferring a TCP stream in a PAN as claimed in claim 6, further comprising switching the receiving mode Rx of the first device to the transmitting mode Tx to continuously transmit the MAC fragment, when the devices at the receiving side have no ACK packet to transmit.

8. A method of decreasing transmission delay of a TCP stream in a network, comprising:
requesting a channel time allocation by transmitting to a coordinator a channel time request command which includes information that a stream to be transmitted is a TCP stream;
allocating a channel time corresponding to the channel time requested based on the channel time request command;
inserting information on the allocated channel time into a synchronous signal broadcast from a coordinator; and
transmitting the TCP stream and a TCP acknowledgement (ACK) in the allocated channel time inserted into the synchronous signal.

9. The method of claim 8, wherein the network is a Personal Area Network (PAN) synchronized with a synchronous signal broadcast from the coordinator.

10. The method of claim 8, wherein a first device at a sending side of the network performs the requesting when the TCP stream is to be sent to a second device at a receiving side of the network, the first device transmits the TCP stream, and the second device transmits the TCP acknowledgement packet upon receipt of the TCP stream.

11. The method of claim 10, wherein the synchronous signal is broadcast to the first and second devices.
